(19) United States
(12) Patent Application Publication
(10) Pub. No.: US 2013/0092612 A1
(43) Pub. Date: Apr. 18, 2013

(54) Sludge thickening and ammonia treatment system

(71) Applicant: Kevin S. Crane, Austin, TX (US)

(72) Inventor: Kevin S. Crane, Austin, TX (US)

(21) Appl. No.: 13/317,316

(22) Filed: Oct. 14, 2011

(51) Int. Cl. C02F 3/30

(52) U.S. Cl. 210/150

(57) ABSTRACT

In a sewage treatment plant that includes anaerobic digestion, ammonia-laden filtrate from anaerobic digestion is treated for breakdown of ammonia and optionally for removal of nitrogen, while at the same time thickening the waste activated sludge, preferably with membrane thickeners. This is efficiently done in a two stage process. Liquid filtrate from this subsystem can then be sent back to the head of plant or it can be disinfected. Preferably the filtrate discharged from the subsystem is denitrified, although in some plants it may be desirable to retain some of the nitrates for odor reduction at the head of plant, providing oxygen to neutralize hydrogen sulphide.

### BACKGROUND OF THE INVENTION

This invention relates to sewage treatment systems, and particularly to enhancements to a system that includes anaerobic digestion in solids handling.

Anaerobic digestion is included in some sewage treatment plants for reasons of energy efficiency. The anaerobic digestion produces biogas, especially methane gas, which can be used as an energy source in the plant. Anaerobic digestion utilizes different bacteria from aerobic digestion in an essentially oxygen-free environment. The sludge or biosolids resulting from the anaerobic process is high in ammonia. Typically this sludge is dewatered, e.g. to about 20% to 25% and then is disposed of through land application. Filtrate or supernatant from the dewatering of the sludge is high in ammonia, and, in a typical anaerobic plant, is recycled to upstream of the clarifiers on the liquid side of the plant.

FIG. 1 indicates a typical prior art system utilizing anaerobic digestion.

On the liquid side of the plant, influent is strained, then typically clarified in a primary clarifier, aerated in an aeration tank where nitrification occurs, and then usually put through secondary clarification. A portion of the solids from secondary clarification known as RAS (recycle activated sludge), which might be at about 1% solids, is recycled to the aeration basin, while the remainder known as WAS (waste activated sludge) typically goes to mechanical thickening and then is delivered to anaerobic digestion, on the solids handling side of the plant, typically at about 3% to 5% solids. This is indicated in the diagram of FIG. 1.

The typical system with anaerobic digestion, although treating the high-ammonia filtrate by recycling through primary clarification and aeration (where nitrification occurs), recycles ammonia back into the system, lowering the biological treatment capacity of the aeration tank while increasing energy requirements.

It is a primary purpose of the invention to treat the sidestream of ammonia-laden filtrate from anaerobic digestion, along with waste activated sludge from the main liquid side of the plant following clarification, in a separate subsystem that both thickens WAS and treats ammonia in an efficient way using membrane thickeners, while optionally removing nitrogen in a denitrification stage. This is achieved by the subsystem as described below.

### SUMMARY OF THE INVENTION

The invention is a physical and biological process that allows wastewater treatment plants, particularly those utilizing anaerobic digestion, to thicken the waste activated sludge (WAS) generated by the activated sludge system while simultaneously removing ammonia present in the filtrate sidestream generated by dewatering equipment.

Pursuant to the invention two influent streams are combined, the filtrate sidestream from the sludge following anaerobic digestion, and WAS resulting after secondary clarification on the liquid side. The subsystem preferably includes a first stage and a second stage. The combined influent stream is introduced to the first stage by entering, in a preferred embodiment, an anoxic basin with the incoming streams providing carbon for heterotrophic bacteria, allowing them to denitrify the sludge within the anoxic basin.

From the anoxic basin, sludge is moved to an aeration basin where nitrifying bacteria present within the WAS are able to convert the incoming ammonia into nitrate in an aerobic environment. Flow from the aeration basin is then pumped into a membrane thickening tank where excess water is removed through the use of membrane separation technology, increasing solids concentration. Sludge in the membrane thickening tank is thoroughly mixed and aerated, allowing further nitrification to take place. A volume of sludge is returned to the anoxic basin where the nitrate produced during aeration, both in the aeration zone and the membrane thickening zone, is converted into nitrogen gas and released to the atmosphere. A portion of the thickened and nitrified flow from the membrane thickening tank is sent to the second stage of the subsystem.

The first stage membrane tank and aeration basin can be reversed in position, with the membrane thickening tank receiving effluent from the anoxic basin, and the thickened sludge from the membrane tank then going to the separate aeration basin. In a further variation, the membrane tank alone can be used for aeration in the first stage of the subsystem, with aeration/nitrification occurring only in the membrane tank. If the anoxic zone is eliminated (as discussed below), then the first tank would be the aeration basin, followed by the membrane separator tank.

The sludge following aeration (either from the membrane or the aeration basin) preferably is divided, with a part being recycled back to the anoxic tank and the remainder, at approximately 2% solids, being delivered to the second stage anoxic basin.

In the second stage anoxic basin the nitrates from the first stage membrane thickening tank/aeration zone are denitrified, along with a recycle flow from within the second stage, converting the nitrates into nitrogen gas released to the atmosphere. Flow from the second stage anoxic basin is delivered to the second stage membrane thickening tank, where sludge is further concentrated by removing excess water using the membranes, in an aerated tank. Like the first stage, the second stage can have a separate aerobic tank either preceding or succeeding the membrane tank. In these aeration zones the remaining ammonia in the sludge is converted into nitrate. The aerated and nitrified sludge is partly recycled back to the anoxic zone and the remainder sent to anaerobic digestion, in a solids handling system such as in FIG. 1 (and from which the NH₃ filtrate emanated), and this may be at about 3% solids.

Flows of permeate from the first stage membrane thickener tank and from the second stage membrane thickener tank will preferably be sent back to the head of the plant, e.g. just downstream of “screening” in the example system shown in FIG. 1. Alternatively, the permeate may be disinfected and discharged to the environment, which can be achieved efficiently because of the high quality of the permeate stream from the membranes.

In some cases a permeate stream sent to the head of plant will advantageously carry nitrates, since the oxygen in the nitrates can reduce odor from hydrogen sulfide present in the influent to the plant. If this is desired, the anoxic zones shown in the first and second stages can be eliminated from the subsystem of the invention, and in that case the aeration zone will be upstream of the membrane zone.

It is thus among the objects of the invention to treat effluent from a main plant liquid side and from anaerobic digestion in a subsystem preferably of two stages, in which WAS thickening and ammonia treatment are efficiently performed. Preferably (but optionally) denitrification is also achieved in the subsystem. These and other objects, advantages and features of the invention will be apparent from the following description of a preferred embodiment, considered along with the accompanying drawings.

### DESCRIPTION OF THE DRAWINGS

FIG. 1 shows schematically an example of a prior art wastewater system including a liquids side and a solids handling side that utilizes anaerobic digestion.

FIG. 2 is a diagram indicating an embodiment of the invention, for use in conjunction with a process such as shown in FIG. 1.

### DESCRIPTION OF PREFERRED EMBODIMENTS

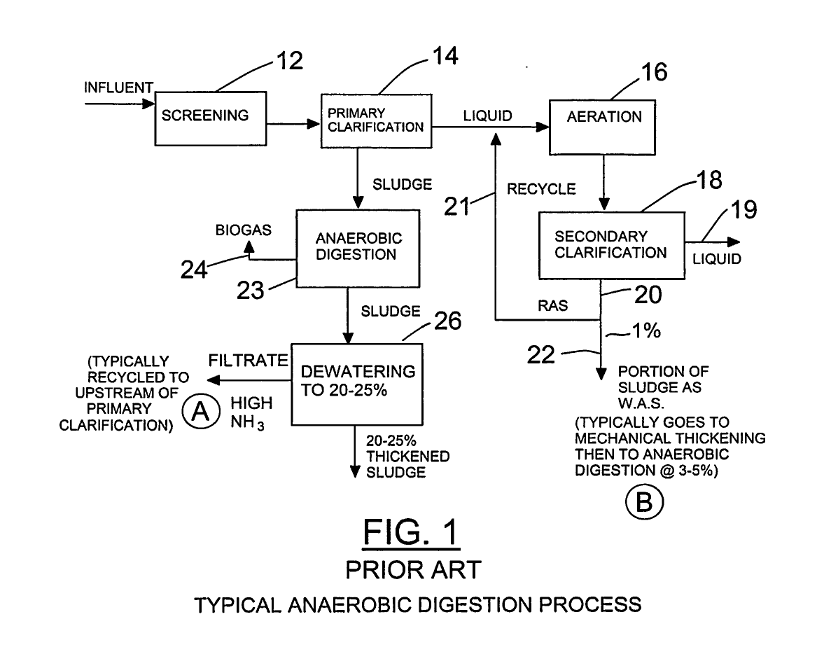

As noted above, FIG. 1 shows an example of a prior art wastewater treatment plant with a liquid side and with a solids handling side including anaerobic digestion. After screening of influent at 12, the wastewater is put through primary clarification 14 where a sludge stream is essentially divided from a liquid stream. The liquid stream is aerated at 16 for nitrification to convert ammonia to nitrate. Typically the stream then enters secondary clarification at 18, where liquid supernatant or permeate at 19 is sent to further clarification or disinfection, with sludge indicated at 20. The sludge flow is divided into recycled activated sludge (RAS), recycled (21) back to the aeration stage, and a waste activated sludge (WAS) flow 22, usually at about 1% solids, which typically goes to mechanically thickening and from there, at about 3% to 5% solids, into anaerobic digestion, at 23 in the solids handling side of the system. The flow from B on the diagram to anaerobic digestion is not shown.

Meanwhile, sludge from primary clarification 14 enters the anaerobic digesters 23. Biogas is emitted as indicated at 24, and this is typically used as an energy source for operating the plant. Anaerobically digested sludge is usually dewatered, as shown at 26, to a solids content which may be about 20% to 25%. The liquid from dewatering, which is high in ammonia and shown at A, typically is recycled to upstream of primary clarification, at 14.

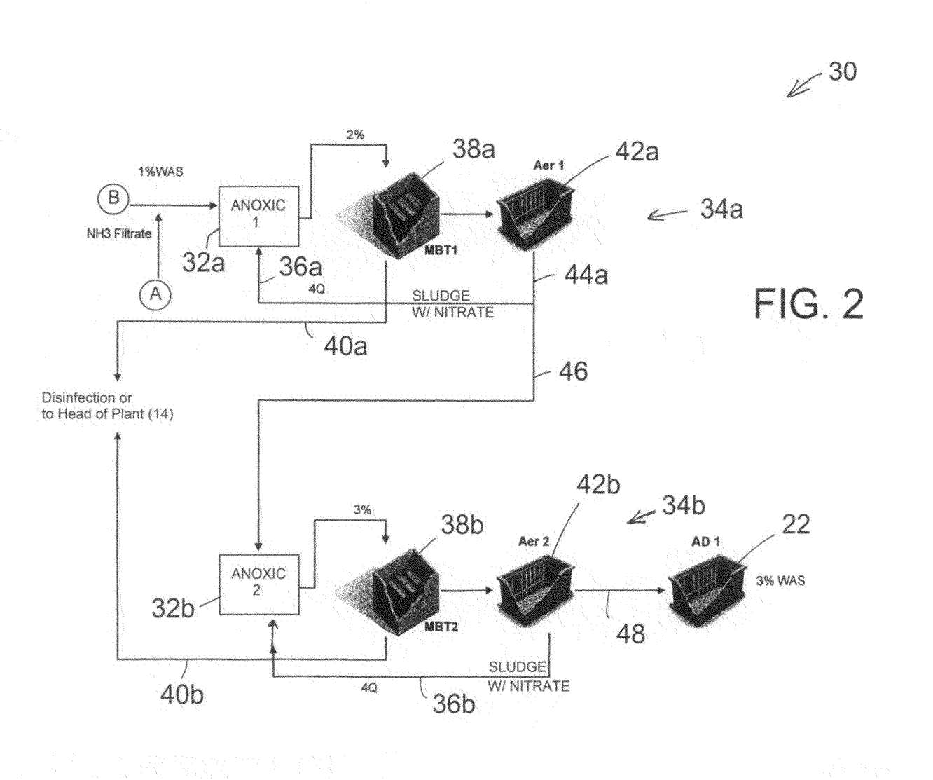

As explained above, pursuant to the invention the flows of WAS at B in FIG. 1 and of ammonia-laden filtrate at A in FIG. 1 are combined and treated in the subsystem 30 of FIG. 2. The subsystem 30 combines these flows of WAS and filtrate, concentrates the resulting WAS with membrane separators, and treats ammonia in the system by nitrification. Preferably, but not necessarily, the subsystem 30 of FIG. 2 also denitrifies the sludge, breaking down nitrate into nitrogen gas released to the atmosphere.

FIG. 2 shows the subsystem including anoxic zones 32a and 32b in first and second stages 34a and 34b. Taking first the first stage 34a, the anoxic zone 32a denitrifies nitrate, much of which comes from a recycle stream 36a. The WAS from the anoxic zone then flows to a membrane thickening/aeration zone 38a, and this may be at about 2% solids. The thickening/aeration zone 38a removes permeate to a flow 40a, while the thickened sludge may be sent to a separate aeration basin 42a. As indicated, a thickened WAS stream 44a, which may be at about 2%, is divided, a part being sent via the stream 36a in a recycle stream back to the anoxic tank 32a and a remainder in a stream 46 being sent to the second stage anoxic zone 36b. The second stage 34b is important in that membrane thickeners work much more efficiently in series as opposed to increasing the number of membranes and liquid in a single tank.

The second stage 34b operates much the same as the first stage 34a. WAS from the stream 46 is denitrified in the anoxic zone 32b, releasing nitrogen gas. The stream then proceeds to a second stage membrane thickening zone 38b, and this may be at about 3% solids. Permeate from the second stage membrane thickening zone flows in a stream 40b to be combined with the stream 40a. This stream, as explained above, is typically sent to the head of the plant, which would be, in the case of the exemplary system of FIG. 1, to primary clarification at 14. Alternatively, these streams may be disinfected, already having a high degree of purity.

From the membrane thickening zone the WAS flows to a separate aeration zone 42b in the embodiment illustrated. The effluent from this aeration zone, which, in combination with the aeration occurring in the membrane thickening zone 38b, nitrifies the sludge to treat ammonia and produce nitrate, is divided into two flows: a portion in a stream 40a to anaerobic digestion, which in the case of the exemplary system of FIG. 1 is indicated at 22. The WAS at this point is preferably at 3% solids. The remaining portion of the sludge from the aeration basin 42b is recycled in a stream 36b to the second stage anoxic zone 32b.

The recycle WAS streams 36a and 36b are indicated as “4Q” in the drawing. This is one preferred embodiment of the system, wherein the rate of flow in the streams 36a and 36b are at about four times the input to the respective subsystems.

As explained above, the membrane thickening zones 38 (a or b) and the aeration zones 42 (a or b) can each be combined into a single membrane thickening/aeration zone if desired. In another alternative, the positions of the aeration zones and the membrane thickening zones can be reversed.

Also as explained above, in some cases it is desired to reduce odor at the head of plant, by neutralizing hydrogen sulfide. In that case the permeate delivered to the head of plant as indicated in the drawing should carry nitrates to break down the hydrogen sulfide and reduce odor. Thus, the anoxic zones 32a and 32b can be eliminated. In that case the membrane thickening zone 38 should not be the first zone in each subsystem; the separate aeration zone would be the first tank of each subsystem.

The above described preferred embodiments are intended to illustrate the principles of the invention, but not to limit its scope. Other embodiments and variations to these preferred embodiments will be apparent to those skilled in the art and may be made without departing from the spirit and scope of the invention as defined in the following claims.

I claim:

1. In a sewage treatment system which includes anaerobic digestion of sludge as well as a liquid side with clarification and aeration of sludge in stages that precede anaerobic digestion, a subsystem for removing ammonia from the system while thickening sludge in the system, the subsystem comprising:
an input to the subsystem of undigested waste activated sludge (WAS) from a clarifier of the liquid side of the system,
an input to the subsystem of filtrate or supernatant liquid from a dewatering step following anaerobic digestion in the sewage treatment system, the filtrate or supernatant liquid being ammonia-laden,
a first stage anoxic zone receiving the inputs of WAS and ammonia-laden liquid in a combined stream in the subsystem, with denitrification occurring in the anoxic zone,
a first stage aeration zone and a first stage membrane thickening zone downstream of the first stage anoxic zone, in which the WAS is aerated for nitrification, producing nitrate from ammonia while also thickening the WAS, removing permeate with membrane separators,
a sludge recycle flow from downstream of the first stage membrane thickening zone to the first stage anoxic zone, the recycle flow delivering a part of the aerated sludge downstream of the first stage membrane thickening zone to the first stage anoxic zone,
a permeate stream from the first stage membrane thickening zone, delivering permeate for further processing or discharge,
a second stage in the subsystem, including a second stage anoxic zone, a second stage membrane thickening zone and a second stage aeration zone, with the second stage anoxic zone receiving another part of the aerated sludge from downstream of the membrane thickening zone in the first stage,
a sludge flow stream from the second stage anoxic zone to the second stage membrane thickening and aeration zones, with a recycle stream from downstream of the second stage membrane thickening zone to the second stage anoxic zone,
a flow of aerated sludge from downstream of the second stage membrane thickening zone to anaerobic digestion in the sewage treatment system, and
a flow of permeate from the second stage membrane thickening zone to combine with the permeate stream from the first stage membrane thickening zone.

2. The system of claim 1, wherein the membrane thickening zone and the aeration zone are combined in a single tank in each of the first stage and the second stage of the subsystem.

3. The system of claim 1, wherein, in each of the first and second stages of the subsystem, the aerobic zone is upstream of the membrane thickening zone.

4. The system of claim 1, wherein, in each of the first and second stages of the subsystem, the aerobic zone is downstream of the membrane thickening zone, so that flows of sludge from downstream of the membrane thickening zone are from the aerobic zone.

5. The system of claim 1, wherein the second stage anoxic zone receives said other part of the aerated sludge at about 2% solids.

6. The system of claim 1, wherein the flow of aerated sludge from downstream of the second stage membrane thickening zone to anaerobic digestion is at about 3% solids.

7. The system of claim 1, wherein the permeate streams from the first and second stage membrane thickening zones flow to a head of plant of the sewage treatment system.

8. In a sewage treatment system which includes anaerobic digestion of sludge as well as a liquid side with clarification and aeration of sludge in stages that precede anaerobic digestion, a subsystem for removing ammonia from the system while thickening sludge in the system, the subsystem comprising:
an input to the subsystem of undigested waste activated sludge (WAS) from a clarifier of the liquid side of the system,
an input to the subsystem of filtrate or supernatant liquid from a dewatering step following anaerobic digestion in the sewage treatment system, the filtrate or supernatant liquid being ammonia-laden,
a first stage aeration zone and a first stage membrane thickening zone receiving the inputs of WAS and ammonia-laden liquid in a combined stream in the subsystem, in which the WAS is aerated for nitrification, producing nitrate from ammonia while also thickening the WAS, removing permeate with membrane separators,
a permeate stream from the first stage membrane thickening zone, delivering permeate to the head of plant of the system,
a second stage in the subsystem, including a second stage membrane thickening zone and a second stage aeration zone, receiving another part of the aerated sludge from downstream of the membrane thickening zone in the first stage,
a flow of aerated sludge from downstream of the second stage membrane thickening zone to anaerobic digestion in the sewage treatment system, and
a flow of permeate from the second stage membrane thickening zone to combine with the permeate stream from the first stage membrane thickening zone,
whereby ammonia is removed in the subsystem as sludge is thickened, and nitrates in the permeate can be effective to break down hydrogen sulfide and reduce odors at the head of plant of the sewage treatment system.

9. The system of claim 8, wherein the membrane thickening zone and the aeration zone are combined in a single tank in each of the first stage and the second stage of the subsystem.

10. The system of claim 8, wherein, in each of the first and second stages of the subsystem, the aerobic zone is upstream of the membrane thickening zone.

11. The system of claim 8, wherein, in each of the first and second stages of the subsystem, the aerobic zone is downstream of the membrane thickening zone, so that flows of sludge from downstream of the membrane thickening zone are from the aerobic zone.

12. The system of claim 8, wherein the second stage receives said other part of the aerated sludge at about 2% solids.

13. The system of claim 8, wherein the flow of aerated sludge from downstream of the second stage membrane thickening zone to anaerobic digestion is at about 3% solids.
